(19) United States
(12) Patent Application Publication
(10) Pub. No.: US 2010/0217750 A1
(43) Pub. Date: Aug. 26, 2010

(54) ARCHIVE APPARATUS, CONVERSION APPARATUS AND CONVERSION PROGRAM

(75) Inventors: Hirotomo TOKORO, Kawasaki (JP); Hiroyuki Naka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/708,929

(22) Filed: Feb. 19, 2010

(30) Foreign Application Priority Data
Feb. 25, 2009 (JP) 2009-42993

(51) Int. Cl. G06F 17/00; G06F 12/16; G06F 12/00

(52) U.S. Cl. 707/640; 707/667; 707/E17.044; 711/E12.001; 711/E12.103

(57) ABSTRACT

An archive apparatus including a plurality of recording media and a processing unit for executing writing into and reading from the plurality of recording media includes an electronic data storage unit, a data format storage unit, an unusable information storage unit, and a conversion destination determining unit. The electronic data storage unit stores electronic data. The data format storage unit stores a data format of the electronic data. The unusable information storage unit stores an unusable and a usable data format as unusable information. The conversion destination determining unit detects, in the data format storage unit, the electronic data of the data format corresponding to the unusable data format, and determines a conversion destination of the unusable data format as a usable data format corresponding to the unusable data format of the unusable information.

### CROSS-REFERENCE TO RELATED APPLICATIONS

This application is based upon and claims the benefit of priority of the prior Japanese Patent Application No. 2009-42993, filed on Feb. 25, 2009, the entire contents of which are incorporated herein by reference.

### FIELD

The embodiment discussed herein is related to an archive apparatus, a conversion apparatus, and a conversion program.

### BACKGROUND

An archive apparatus is conventionally used to store digital contents free of alteration of data such as music, movies, electronic mail, medical images, text data, etc. in an integrated manner over a long period of time. The archive apparatus, connected to a plurality of terminals through a network, stores various digital contents (hereinafter, referred to as the data) received from each terminal, and in response to an access request of a user, transfers the stored data to the terminal of the user.

The archive apparatus includes a plurality of recording media (disk array, tape library, etc.) and a processing unit for writing into and reading from the recording media. The processing unit, at the time of writing the data received from each terminal in the recording media, generates and stores metadata (reception date, transmitter, storage area, etc.) for the received data. In the processing unit, for example, an ID for uniquely specifying the received data and an ID for uniquely specifying a recording medium to store the received data are generated as an archive ID, and the archive ID thus generated is added to the metadata and stored. Then, the processing unit, in response to an access request from the user, accesses the metadata, and by reading the corresponding data from the recording medium, transfers the data to the terminal of the user.

Further, in order to meet the recent demand to store the drastically increasing amount of data at lower cost, an archive apparatus has recently been known which stores the data with the data format converted in accordance with the degree of importance. Specifically, the archive apparatus judges the degree of importance of data based on a specific electronic signature or keyword contained in the data, and upon judgment that the degree of importance of the data is high (to be held for a long period of time), converts the data format into a format adapted for long storage and stores the data in such a format. The reference document is Japanese Laid-open Patent Publication No. 2006-260017.

The conventional embodiment described above, however, poses the problem that the user cannot always use the read out data. Specifically, according to the conventional embodiment, the data is held in the format at the time when the data is stored. In the case where the format of the data cannot be used at the present time, the user is required to convert the data format into a format usable at the present time.

### SUMMARY

According to an aspect of the invention, an archive apparatus including a plurality of recording media and a processing unit for executing writing into the recording media and reading from the plurality of recording media includes an electronic data storage unit, a data format storage unit, an unusable information storage unit, and a conversion destination determining unit. The electronic data storage unit stores the electronic data received from a terminal. The data format storage unit stores the data format of the electronic data stored in the electronic data storage unit. The unusable information storage unit stores, in association with each other, an unusable data format unusable at the terminal and a usable data format usable in place of the unusable format at the terminal as unusable information. The conversion destination determining unit detects, in the data format storage unit, the electronic data of the data format corresponding to the unusable data format of the unusable information stored in the unusable information storage unit, and determines a conversion destination of the unusable data format of the detected electronic data as a usable data format corresponding to the unusable data format of the unusable information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are diagrams for describing the outline of the archive apparatus according to a first embodiment.

FIGS. 2A, 2B, 2C and 2D are diagrams for describing the features of the archive apparatus according to the first embodiment.

FIG. 3 is a diagram for describing the configuration of the archive apparatus according to the first embodiment.

FIG. 4 is a diagram for describing the steps of the metadata storage process according to the first embodiment.

FIG. 5 is a diagram for describing the steps of the process for storing the unsupported format information according to the first embodiment.

FIG. 6 is a diagram for describing the steps of the process for creating the format conversion adapted information according to the first embodiment.

FIG. 7 is a diagram for describing the steps of the format conversion process according to the first embodiment.

FIGS. 8A, 8B, 8C and 8D are diagrams for describing the outline and the features of the archive apparatus according to a second embodiment.

FIG. 9 is a diagram for describing the configuration of the archive apparatus according to the second embodiment.

FIG. 10 is a diagram for describing the steps of the process for automatically generating the unsupported format information according to the second embodiment.

FIG. 11 is a diagram for describing a computer to execute the conversion program according to the first embodiment.

### DESCRIPTION OF EMBODIMENTS

An archive apparatus, a conversion apparatus, and a conversion program according to embodiments of the present invention disclosed herein are described in detail below with reference to the accompanying drawings. The embodiments described below represent an archive apparatus for executing the conversion program disclosed in the invention.

### First Embodiment

[Outline and Features of Archive Apparatus According to First Embodiment]

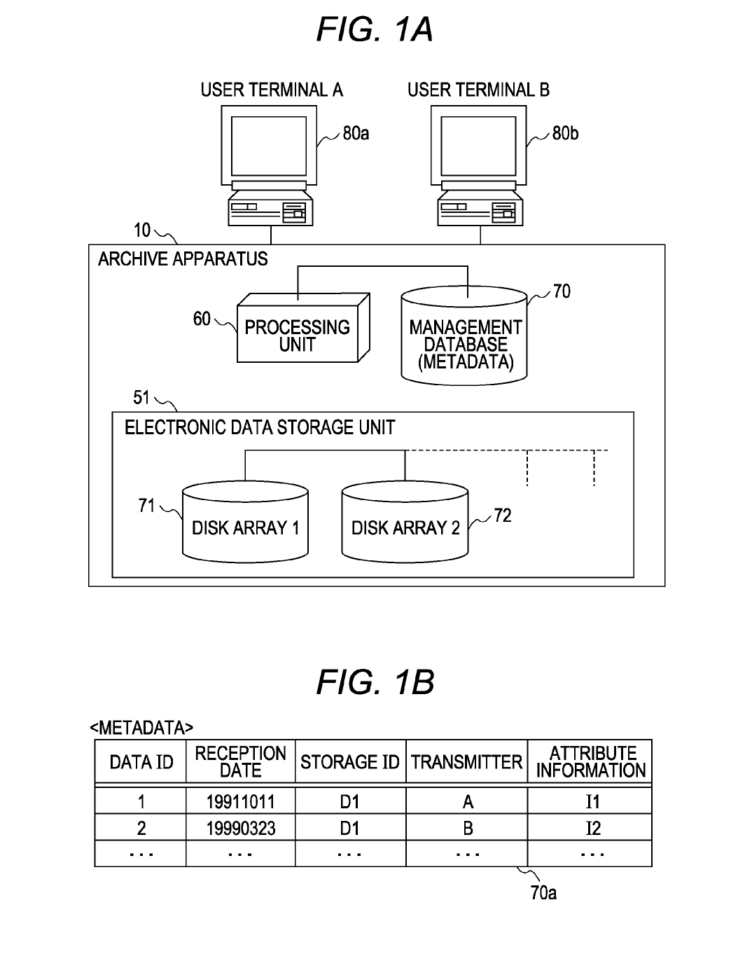

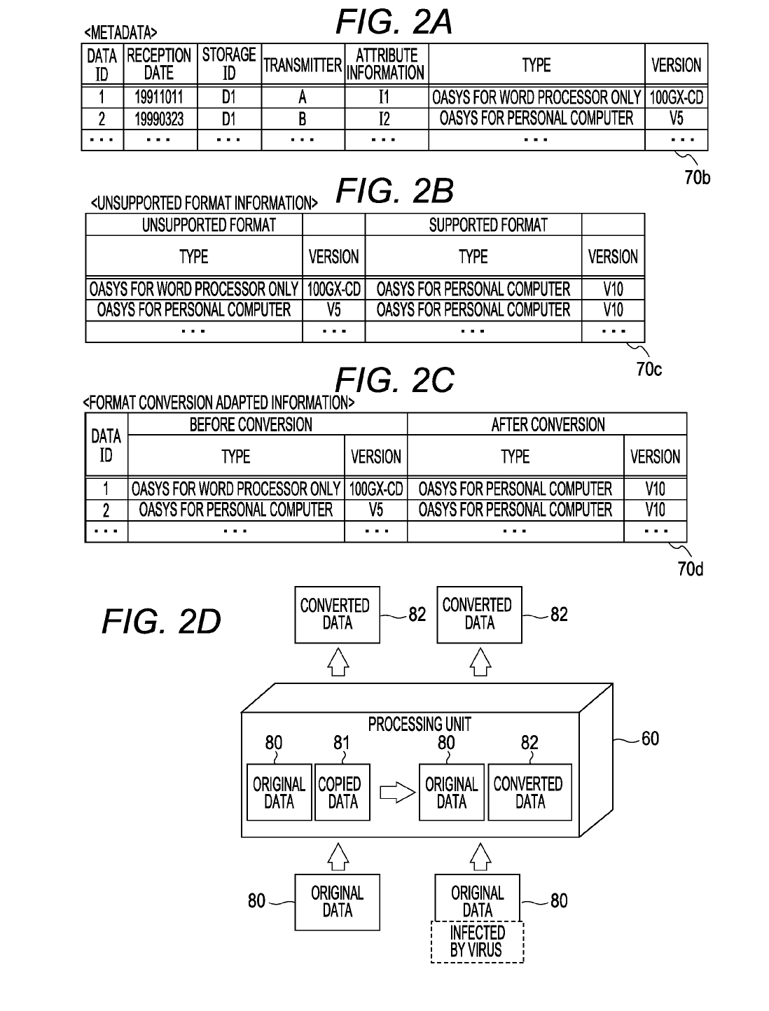

First, the outline and the features of the archive apparatus according to a first embodiment are described with reference to FIGS. 1 and 2. FIGS. 1A and 1B are diagrams for describing the outline of the archive apparatus according to the first embodiment. FIGS. 2A, 2B, 2C and 2D are diagrams for describing the features of the archive apparatus according to the first embodiment.

According to the first embodiment, the archive apparatus, which is connected to a plurality of user terminals through a network, stores electronic data received from each user terminal and, in accordance with access requests received from users through the user terminals, transfers the stored electronic data to the user terminals specified by the users. In the description below, “electronic data” is referred to as “data.”

An archive apparatus 10 according to the first embodiment, as illustrated in FIG. 1A, for example, includes a processing unit 60 for executing the process of storing and transferring the data and an electronic data storage unit 51 for storing the data, and is connected to a plurality of user terminals (the user terminals A 80a and B 80b are illustrated in FIG. 1). The archive apparatus 10 according to the first embodiment, as illustrated in FIG. 1A, further includes, in the electronic data storage unit 51, a plurality of disk arrays as recording media for recording the data. Although only two disk arrays (disk array 171 and disk array 272) are illustrated in FIG. 1A, the archive apparatus 10 according to the first embodiment may include any number of disk arrays. Furthermore, the archive apparatus 10 according to the first embodiment may include a plurality of tape libraries as recording media instead of the disk arrays. Furthermore, in spite of the fact that only two user terminals are illustrated in FIG. 1A, the archive apparatus 10 according to the first embodiment may be connected to any number of user terminals.

In the archive apparatus 10 according to the first embodiment, the data received from the user terminals through the network are stored in any of the recording media by the processing unit 60. The processing unit 60 stores the received data in the recording media, and generates metadata of the received data and stores the metadata in a management database 70. The management database 70 according to this embodiment, as illustrated in FIG. 1A, is a storage unit other than the electronic data storage unit 51 included in the archive apparatus 10.

Specifically, the processing unit 60 generates metadata that associates each block of received data with an ID for uniquely specifying the block of data, a block of data reception date, an ID for uniquely specifying the recording medium to store the block of data, an ID for uniquely specifying a transmitter of the block of data, and data attribute information. All the types of data are stored in the management database 70. The data attribute information includes a data name, a data creator, related keywords and the like.

For example, when data received from the user terminal A is stored in the disk array 1 on Oct. 11, 1991, the processing unit 60, as illustrated in FIG. 1B, generates, as metadata 70a, “data ID: 1, storage ID: D1, reception date: 19911011, transmitter: A, attribute information: I1”, and stores the generated metadata 70a in the management database 70. “D1” is the ID for specifying disk array 1 as the storage, and “A” is the ID for specifying the user terminal A as the transmitter. For example, when the data received from the user terminal B on Mar. 23, 1999 is stored in the disk array 1, the processing unit 60, as illustrated in FIG. 1B, generates, as the metadata 70a, “data ID: 2, storage ID: D1, reception date: 19990323, transmitter: B, attribute information: I2”, and stores the generated metadata 70a in the management database 70.

The processing unit 60, upon reception of a data read request from a user terminal, accesses the metadata 70a stored in the management database 70, and by reading the requested data from the electronic data storage unit 51, transfers the requested data to the user terminal. Upon reception of the data name as a data read request from the user terminal B 80b, for example, the processing unit 60 accesses the metadata 70a and reads the data corresponding to the received data name from the recording medium, and transfers the data to the user terminal B 80b.

An aspect of the archive apparatus 10 according to the first embodiment lies in that the data read by the user may be reliably used. When the archive apparatus 10 according to the first embodiment stores the metadata of the block of data received from a user terminal in the management database 70, the archive apparatus 10 also stores the format of each block of data as metadata. Specifically, in the archive apparatus 10 according to the first embodiment, the type and the version of an application used at the time of data creation are also stored as the format of each block of data in the management database 70 in association with the metadata.

The processing unit 60 of the archive apparatus 10 according to the first embodiment, as illustrated in FIG. 2A, for example, generates “data ID: 1, reception date: 19911011, storage ID: D1, transmitter: A, attribute information: I1, type: OASYS (registered trademark) for word processor only, version: 100GX-CD” as metadata 70b of data ID: 1, and stores the metadata 70b in the management database 70. Furthermore, the processing unit 60 of the archive apparatus 10 according to the first embodiment, as illustrated in FIG. 2A, generates “data ID: 2, reception date: 19990323, storage ID: D1, transmitter: B, attribute information: I2, type: OASYS (registered trademark) for personal computer, version: V5” as the metadata 70b of data ID:2, and stores the metadata in the management database 70.

The archive apparatus 10 according to the first embodiment stores, in association with each other, a data format unusable at the present time point and a data format usable at the present time point in the management database 70, as unsupported format information, in regards to a plurality of the user terminals connected to the archive apparatus 10. Specifically, the archive apparatus 10 according to the first embodiment stores, in association with each other, the type and/or the version of the application unusable at the present time point (unsupported format) and the type and/or the version of the application usable at the present time point (supported format), as the unsupported format information in the management database 70.

For example, the archive apparatus 10 according to the first embodiment is connected to an information center, not illustrated, through a network, and by making a periodic inquiry to the information center, acquires the unsupported format information at the present time point. The information center manages the information (e.g., update history information) on the type and the version of the applications installed in all or most of the user terminals connected to the archive apparatus 10, and records the unsupported formats and the supported formats for each of the user terminals at the present time point.

When the archive apparatus 10 is not connected to the information center through the network, the manager of the archive apparatus 10 may input the unsupported format and the supported format acquired from the information center into the archive apparatus 10. As a result, the archive apparatus 10 according to the first embodiment stores the unsupported format information in the management database 70. A manager may acquire the unsupported format and the supported from the information center, for example, when the firmware of the archive apparatus 10 is updated.

When it is desired to designate the unsupported format rapidly, the manager may input the particular unsupported format and the corresponding supported format to the archive apparatus 10.

Assume that the archive apparatus 10 according to the first embodiment has acquired, by the process described above, information indicating “type: OASYS for word processor only, version: 100GX-CD” as the unsupported format and “type: OASYS for personal computer, version: V10” as the supported format. The archive apparatus 10 stores unsupported format information 70c as described below. Specifically, the archive apparatus 10 according to the first embodiment, as illustrated in FIG. 2B, stores “‘unsupported format, type: OASYS for word processor only, version: 100GX-CD’, ‘supported format, type: OASYS for personal computer, version: V10’” as the unsupported format information 70c in the management database 70.

In the archive apparatus 10 according to this embodiment, the unsupported format information with the same type of the data format but different versions may also be stored in the management database 70 in the same manner as in the aforementioned case. When the archive apparatus 10 according to the first embodiment acquires the information with “type: OASYS for personal computer, version: V5” as the unsupported format, and “type: OASYS for personal computer, version: V10” as the supported format, for example, the unsupported format information 70c is stored as described below. That is, the archive apparatus 10 according to the first embodiment, as illustrated in FIG. 2B, stores “‘unsupported format, type: OASYS for personal computer, version: V5’, ‘supported format, type: OASYS for personal computer, version: V10’” as the unsupported format information 70c in the management database 70.

When the information on the supported format corresponding to the unsupported format cannot be acquired, the archive apparatus 10 according to the first embodiment stores the unsupported format information 70c in the management database 70 with a specific format as the supported format information corresponding to the unsupported format. The archive apparatus 10 according to the first embodiment, if unable to acquire the supported format information, stores the unsupported format information 70c with “type: PDF” or “type: image format” as the supported format in association with the unsupported format.

Furthermore, in the archive apparatus 10 according to the first embodiment, assuming that the supported format is changed to the unsupported format regarding the unsupported format information already stored, the type or the version stored as the supported format is updated to the type or the version usable at the present time point. Assume, for example, that the archive apparatus 10 according to the first embodiment stores the unsupported format information “‘unsupported format, type: OASYS for word processor only, version: 100GX-CD’, ‘supported format, type: OASYS for personal computer, version: V5’”. When the information is acquired with “type: OASYS for personal computer, version: V5” as unsupported format information and “type: OASYS for personal computer, version: V10” as supported format information, then the archive apparatus 10 according to the first embodiment updates the unsupported format information “supported format, type: OASYS for personal computer, version: V5”. Specifically, the archive apparatus 10 according to the first embodiment updates the unsupported format information to “‘unsupported format, type: OASYS for word processor only, version: 100GX-CD’, ‘supported format, type: OASYS for personal computer, version: V10’”.

When the supported format information of unsupported format associated with “type: PDF” or “type: image format” as the supported format is acquired, the archive apparatus 10 according to the first embodiment updates the unsupported format information “type: PDF” or “type: image format” to the acquired supported format information.

Although the unsupported format and the supported format in the text data are described above as the unsupported format information, the archive apparatus 10 according to the first embodiment may also store the unsupported format and the supported format of various electronic data such as audio and video data in the management database 70 as unsupported format information. For example, the archive apparatus 10 according to the first embodiment may store the unsupported format information of the image data as “‘unsupported format, type: BMP format’, ‘supported format, type: JPEG format’” in the management database 70.

The archive apparatus 10 according to the first embodiment detects the data of the unsupported format in the unsupported format information 70c in the metadata, and determines a conversion destination of the unsupported format of the detected data as the supported format corresponding to the unsupported format in the unsupported format information 70c. Further, the archive apparatus 10 according to the first embodiment stores format conversion adapted information set in association with the conversion destination determined for each block of data of the unsupported format in the unsupported format information 70c, in the management database 70.

The archive apparatus 10 according to the first embodiment, for example, detects “data ID: 1” from metadata 70d based on the unsupported format information, and determines the conversion destination of the unsupported format of “data ID: 1” as “type: OASYS for personal computer, version: V10”. The archive apparatus 10 according to the first embodiment, as illustrated in FIG. 2C, stores the format conversion adapted information “‘data ID: 1’, ‘before conversion, type: OASYS for word processor only, version: 100GX-CD’, ‘after conversion, type: OASYS for personal computer, version: V10’” in the management database 70.

Similarly, the archive apparatus 10 according to the first embodiment detects the data which has the same type of data format and in which the version has become an unsupported format from the metadata 70c using the unsupported format information, and after determining the version of the conversion destination of the unsupported format, stores the format conversion adapted information in the management database 70. For example, the archive apparatus 10 according to the first embodiment, as illustrated in FIG. 2C, stores the format conversion adapted information “‘data ID: 2’, ‘before conversion, type: OASYS for personal computer, version: V5’, ‘after conversion, type: OASYS for personal computer, version: V10”. The format conversion adapted information may be created or updated each time the unsupported format information is updated.

In the archive apparatus 10 according to the first embodiment, the format to be converted may be designated for specific blocks of data at the discretion of the user. Specifically, in the archive apparatus 10 according to the first embodiment, format conversion adapted information input by the user may be stored in the management database 70.

The archive apparatus 10 according to the first embodiment, upon reception of a request from a user terminal to read the data corresponding to the data ID stored in the format conversion adapted information, reads the requested data from the electronic data storage unit 51 and then copies the data. The archive apparatus 10 according to the first embodiment converts the type or the version of the copied data based on the format conversion adapted information, and transfers the converted data to the user terminal.

Specifically, the processing unit 60 of the archive apparatus 10 according to the first embodiment, as illustrated in FIG. 2D, reads original data 80 as the requested data from the electronic data storage unit 51, and creates copied data 81 as a copy of the original data 80. Then, the processing unit 60 of the archive apparatus 10 according to the first embodiment transfers, to the user terminal, converted data 82 with the data format of the copied data 81 converted to the supported format based on the format conversion adapted information.

The archive apparatus 10 according to the first embodiment, upon reception of a request to read the data corresponding to “data ID: 1”, for example, reads the original data 80 of data ID: 1 from the storage D1 and copies the data to generate copied data 81. Then, the processing unit 60 of the archive apparatus 10 according to the first embodiment, by accessing the format conversion adapted information illustrated in FIG. 2C, converts the format of the copied data 81 “data ID: 1” to “type: OASYS for personal computer, version: V10”, and transfers the converted copied data 81 to the user terminal.

The archive apparatus 10 according to the first embodiment also checks for the presence or absence of a computer virus in the data desired by the user, and upon detection that the data is infected by a virus, exterminates the virus. Specifically, the processing unit 60 of the archive apparatus 10 according to the first embodiment, as illustrated in FIG. 2D, after exterminating the computer virus from the original data 80 infected thereby, copies the original data 80 to generate the copied data 81, and transfers the converted data 82 of the copied data 81 to the user terminal. The computer virus may alternatively be exterminated after copying the original data 80.

Furthermore, the archive apparatus 10 according to the first embodiment, when transferring the data to the user terminal, confirms the consistency of the data by using a hash value as a pseudo-random number used for identifying the data. For example, the archive apparatus 10 according to the first embodiment, in storing the data received from the user terminal, calculates the hash value of each block of data, and stores the metadata with the calculated hash value in the management database 70. Then, the archive apparatus 10 according to the first embodiment, when transferring the data in response to the read request from the user terminal, compares the hash value and confirms the consistency of the data.

As a result, the archive apparatus 10 according to the first embodiment may convert a long-held data format to a presently usable data format and transfer the converted data to the user terminal. Then, the archive apparatus 10, as described above, allows the user to reliably use the data that has been read.

The archive apparatus 10 according to the first embodiment, in order to prevent the same data from being duplicated, may also have a single-instance function which, when the same data as data that was previously written is received, refers to the metadata and does not perform writing of the same data again in the recording medium. In other words, the archive apparatus 10 having the single-instance function executes the process of writing only received data that is different from the data written previously into the recording medium. For example, the archive apparatus 10 according to the first embodiment calculates a hash value for specifying the data and stores the metadata with the calculated hash value each time a block of data is received. Thus, the archive apparatus 10 according to the first embodiment, at the time of storing the received data, refers to the hash value of the metadata and, only when the same hash value is absent, executes the data write process.

Furthermore, in order to prevent the stored data from being illegally altered, the archive apparatus 10 according to the first embodiment may have a WORM (write once read many) function whereby the data once stored may be only read. Specifically, the archive apparatus 10 according to the first embodiment having the WORM function permits no data to be overwritten and stores new data in another storage. For example, the archive apparatus 10 according to the first embodiment does not execute a write process on data with the same file name as already stored data.

Further, the archive apparatus 10 according to the first embodiment, in order to prevent data loss due to degeneration of the recording medium, may also have a metabolic function of automatically transferring the data stored in a degenerated recording medium to another recording medium. Specifically, the archive apparatus 10 according to the first embodiment having the metabolic function, upon detection of the degeneration of a recording medium by self-diagnosis, transfers the data stored in the particular recording medium to another recording medium that is not degenerated. The archive apparatus 10 according to the first embodiment having the metabolic function may create or update the format conversion adapted information at the time of transferring the data by the metabolic function.

The examples described above are not limitative but illustrative, and the archive apparatus 10 according to the first embodiment may execute the process of converting various data formats including music data and image data as well as text data.

[Configuration of Archive Apparatus According to First Embodiment]

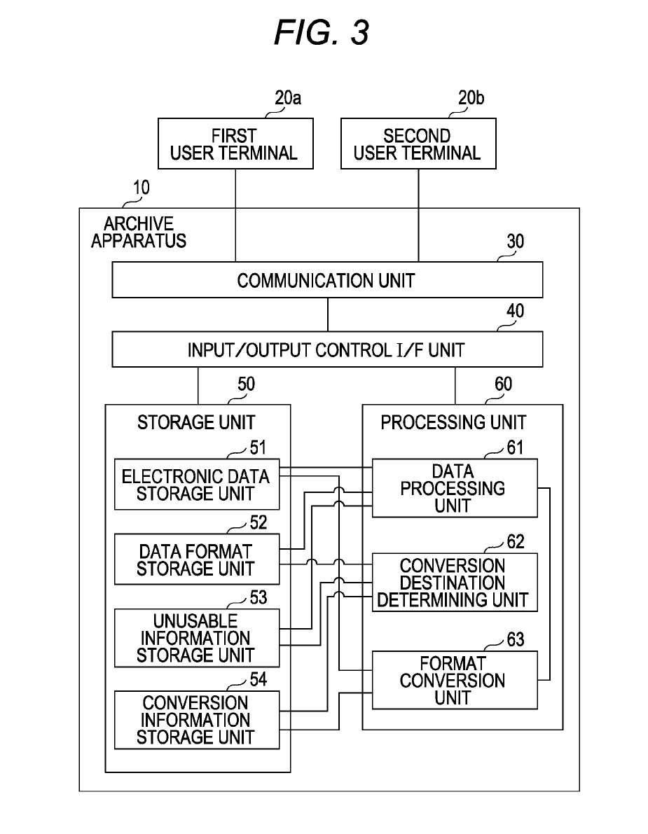

Next, the configuration of the archive apparatus 10 according to the first embodiment is described with reference to FIG. 3. FIG. 3 is a diagram for describing the configuration of the archive apparatus 10 according to the first embodiment.

As illustrated in FIG. 3, the archive apparatus 10 according to the first embodiment includes a communication unit 30, an input/output control I/F unit 40, a storage unit 50, and a processing unit 60. Further, the archive apparatus 10 according to the first embodiment, as illustrated in FIG. 3, is connected to a first user terminal 20a and a second user terminal 20b. Furthermore, the archive apparatus 10 according to the first embodiment is connected also to an information center not illustrated. The information center is described in detail later.

The first user terminal 20a and the second user terminal 20b, connected to the archive apparatus 10 through a network (not illustrated), issue a write request or a read request to the archive apparatus 10. Although only two user terminals including the first user terminal 20a and the second user terminal 20b are illustrated in FIG. 3, any number of user terminals may be connected to the archive apparatus 10.

The communication unit 30 controls communication with the user terminals such as the first user terminal 20a and the second user terminal 20b connected to the archive apparatus 10, and transfers the write data received from a user terminal to a data processing unit 61, described later, through the input/output control I/F unit 40. Furthermore, the communication unit 30, upon reception of a read request from a user terminal, transfers the read request information to a format conversion unit 63, described later, through the input/output I/F unit 40. Furthermore, the communication unit 30 controls communication with the information center (described later).

The input/output control I/F unit 40 is an interface to relay data transmitted and received to and from the communication unit 30, the storage unit 50, and the processing unit 60.

The storage unit 50 has stored therein electronic data (hereinafter, referred to as “data”) received from the user terminal, such as the first user terminal 20a or the second user terminal 20b, and each block of data created from the received data by the processing unit 60 described later. The storage unit 50, as illustrated in FIG. 3, includes the electronic data storage unit 51, a data format storage unit 52, an unusable information storage unit 53, and a conversion information storage unit 54. The data format storage unit 52, the unusable information storage unit 53, and the conversion information storage unit 54 correspond to the management database 70 illustrated in FIG. 1A.

The electronic data storage unit 51 stores the data received from the user terminal such as the first user terminal 20a or the second user terminal 20b through the communication unit 30. For example, the electronic data storage unit 51 stores the digital contents free of data alteration such as music, movies, electronic mail, images, and the text data received from the first user terminal 20a and the second user terminal 20b. The electronic data storage unit 51 includes a plurality of disk arrays (FIG. 1A) as recording media for recording the data.

The data format storage unit 52, the unusable information storage unit 53, and the conversion information storage unit 54 store a result of a process executed by the processing unit 60 described later. Specifically, the data format storage unit 52 stores the metadata, the unusable information storage unit 53 stores the unsupported format information, and the conversion information storage unit 54 stores the format conversion adapted information. The contents of data and information stored in the data format storage unit 52, the unusable information storage unit 53, and the conversion information storage unit 54 will be described later.

The processing unit 60 executes various processes in response to the write request or the read request received from the user terminals such as the first user terminal 20a and the second user terminal 20b. The processing unit 60 includes the data processing unit 61, a conversion destination determining unit 62, and the format conversion unit 63 as illustrated in FIG. 3.

Each time a write request data from the user terminal such as the first user terminal 20a or the second user terminal 20b is received, the data processing unit 61 stores the received data in the electronic data storage unit 51. For example, the data processing unit 61 stores, in the electronic data storage unit 51, digital contents free of alteration such as music, movies, electronic mail, images or text data received from the first user terminal 20a or the second user terminal 20b.

The data processing unit 61 also generates metadata for each block of received data and stores the metadata in the data format storage unit 52. Specifically, the data processing unit 61 generates, for each received block of data, the metadata containing an ID for uniquely specifying the block of data, a reception date, an ID for uniquely specifying the recording medium for storing the block of data, an ID for uniquely specifying the data transmitter, data attribute information, and a data format, and stores the metadata in association with each other in the data format storage unit 52. In the process, the data processing unit 61 stores, in the data format storage unit 52, the type and/or the version of the application used at the time of creating the data as the data format. The data attribute information includes the data name, the data creator, and related key words.

When the data received from the first user terminal 20a on Oct. 11, 1991 is stored in the disk array 1 made up of recording media included in the electronic data storage unit 51, for example, the data processing unit 61 generates the metadata 70b illustrated in FIG. 2A, and stores the metadata in the data format storage unit 52. Specifically, the data processing unit 61 generates metadata as “data ID: 1, reception date: 19911011, storage ID: D1, transmitter: A, attribute information: I1, type: OASYS (registered trademark) for word processor only, version: 100GX-CD” and stores the metadata in the data format storage unit 52.

When data received from the second user terminal 20b on Mar. 23, 1999 is stored in the disk array 1, for example, the data processing unit 61 generates the metadata illustrated in FIG. 2A and stores the metadata in the data format storage unit 52. Specifically, the data processing unit 61 generates the metadata as “data ID: 2, reception date: 19990323, storage ID: D1, transmitter: B, attribute information: I2, type: OASYS (registered trademark) for personal computer, version: V5” and stores the metadata in the data format storage unit 52. The transmitter B is the ID for identifying the second user terminal 20b uniquely.

The data processing unit 61 may have the single-instance function whereby in order to prevent the same data from being duplicated, the metadata is accessed and when the same data as the data previously subjected to the write process is received, the same data is not written into the recording medium. Specifically, the data processing unit 61 having the single-instance function writes only received data that is different from the previously written data into the recording media. For example, each time data is received, the data processing unit 61 calculates the hash value specifying the data and stores the metadata with the calculated hash value attached thereto. The archive apparatus 10 according to the first embodiment, by referring to the hash value of the metadata at the time of storing the received data, writes the data only when the same hash value does not exist.

The data processing unit 61 may also have the WORM (write once read many) function, by which data stored once may only be read, to prevent the illegal alteration of the stored data. Specifically, the data processing unit 61 including the WORM function stores the data in another storage as a newly written data without overwriting any data. For example, the data processing unit 61 executes no write process for data with the same file name as already stored data.

Furthermore, in order to prevent the loss of the data due to the degeneration of the recording medium, the data processing unit 61 may have a metabolic function. Specifically, the data processing unit 61 having the metabolic function diagnoses the state of the recording medium, and upon detection of degeneration, transfers the data from the degenerated recording medium to another recording medium not yet degenerated.

The data processing unit 61 stores, in the unusable information storage unit 53, the unsupported format information that includes, in association with each other, the data format presently unusable and the data format presently usable corresponding to a plurality of user terminals connected to the archive apparatus 10. Specifically, the data processing unit 61 stores, in the unusable information storage unit 53, the unsupported format information including the type or version of the presently unusable application (unsupported format) and the type or version of the presently usable application (supported format) in association with each other.

For example, the data processing unit 61, by periodically making an inquiry to the information center described above, acquires the presently unsupported format information, and stores the acquired unsupported format information in the unusable information storage unit 53. The information center manages update history information on the type and the version of the applications installed in all or most of the user terminals connected to the archive apparatus 10, and records the unsupported formats and the supported formats for the present user terminals.

If the archive apparatus 10 is not connected to the information center through the network, on the other hand, a manager of the archive apparatus 10 may acquire the unsupported format information from the information center and input the unsupported format information into the archive apparatus 10 through an input unit not illustrated. The data processing unit 61 stores the input unsupported format information in the unusable information storage unit 53. The manager may acquire the unsupported formats and the supported formats from the information center, for example, at the time of updating the firmware of the archive apparatus 10.

Furthermore, when the unsupported format and the corresponding supported format designated at the discretion of the manager are input through an input unit not illustrated, the data processing unit 61 stores the unsupported format information having the input unsupported format in association with the input supported format in the unusable information storage unit 53.

The data processing unit 61, upon acquisition of the information by the process described above indicating that “type: OASYS for word processor only, version: 100GX-CD” is the unsupported format and “type: OASYS for personal computer, version: 10” is the supported format, for example, stores the following unsupported format information. Specifically, the data processing unit 61 stores the unsupported format information “‘unsupported format, type: OASYS for word processor only, version: 100GX-CD’, ‘supported format, type: OASYS for personal computer, version: V10’” in the unusable information storage unit 53 (FIG. 2B).

Similarly, the unsupported format information having the same type of the data format but a different version is also stored by the data processing unit 61 in the unusable information storage unit 53. For example, the data processing unit 61, upon acquisition of the information indicating that “type: OASYS for personal computer, version: V5” is the unsupported format and “type: OASYS for personal computer, version: V10” is the supported format, stores the following unsupported format information. Specifically, the data processing unit 61 stores the unsupported format information “‘unsupported format, type: OASYS for personal computer, version: V5’, ‘supported format, type: OASYS for personal computer, version: V10’” in the unusable information storage unit 53 (FIG. 2B).

If the information on the supported format corresponding to the unsupported format cannot be acquired, on the other hand, the data processing unit 61 stores, as the information on the supported format, the unsupported format information with a specific format set in association with the unsupported format in the unusable information storage unit 53. If the information on the supported format cannot be acquired, for example, the data processing unit 61 stores the unsupported format information in which “type: PDF” or “type: image format” is set as the supported format in association with the unsupported format in the unusable information storage unit 53.

When the supported format is changed to the unsupported format in the already stored unsupported format information, the data processing unit 61 updates the type or the version stored as the supported format to the type or the version usable at the present time point. For example, assume that the unusable information storage unit 53 has stored therein the unsupported format information “‘unsupported format, type: OASYS for word processor only, version: 100GX-CD’, ‘supported format, type: OASYS for personal computer, version: V5’”. In the case of acquiring the information including the unsupported format “type: OASYS for personal computer, version: V5” and the supported format “type: OASYS for personal computer, version: V10”, then the data processing unit 61 updates “supported format, type: OASYS for personal computer, version: V5” in the unsupported format information. Specifically, the data processing unit 61 updates the unsupported format information to “‘unsupported format, type: OASYS for word processor only, version: 100GX-CD’, ‘supported format, type: OASYS for personal computer, version: V10’”.

Upon acquisition of the supported type information with the unsupported format in association with the supported format “type: PDF” or “type: image format”, the data processing unit 61 updates the unsupported format information “type: PDF” or “type: image format” to the supported format information acquired.

Although the unsupported format information including the unsupported format and the supported format of the text data are described above, the data processing unit 61 may also store, as the unsupported format information, the unsupported format and the supported format of various electronic data such as audio and video data, in the unusable information storage unit 53. For example, the data processing unit 61 may store “‘unsupported format, type: BMP format’, ‘supported format, type: JPEG format’” as the unsupported format information of the image data in the unusable information storage unit 53.

The conversion destination determining unit 62 detects, from the metadata stored in the data format storage unit 52, the data of the unsupported format in the unsupported format information stored in the unusable information storage unit 53. For example, the conversion destination determining unit 62 acquires the unsupported format “type: OASYS for word processor only, version: 100GX-CD” from the unsupported format information illustrated in FIG. 2B and detects “data ID: 1” of the associated data from the metadata illustrated in FIG. 2A.

Then, the conversion destination determining unit 62 determines the conversion destination of the unsupported format of the detected electronic data as the supported format corresponding to the unsupported format in the unsupported format information. For example, the conversion destination determining unit 62 determines the conversion destination of “data ID: 1” as the supported format “type: OASYS for personal computer, version: V10” corresponding to the unsupported format “type: OASYS for word processor only, version: 100GX-CD” in the unsupported format information illustrated in FIG. 2B.

Further, the conversion destination determining unit 62 stores, in the conversion information storage unit 54, the format conversion adapted information corresponding to the conversion destination determined for each block of data of an unsupported format in the unsupported format information. For example, the conversion destination determining unit 62 stores the format conversion adapted information “‘data ID: 1’, ‘before conversion, type: OASYS for word processor only, version: 100GX-CD’, ‘after conversion, type: OASYS for personal computer, version: V10’” in the conversion information storage unit 54 (FIG. 2C).

Similarly, the conversion destination determining unit 62, using the unsupported format information stored in the unusable information storage unit 53, detects, from the metadata, the data with the same type of data format and the version changed to the unsupported format, and after determining the version of the conversion destination of the unsupported format, stores the format conversion adapted information in the conversion information storage unit 54. For example, the conversion destination determining unit 62 stores the format conversion adapted information “‘data ID: 2’, ‘before conversion, type: OASYS for personal computer, version: V5’, ‘after conversion, type: OASYS for personal computer, version: V10’” in the conversion information storage unit 54 (FIG. 2C).

In the conversion destination determining unit 62, certain data with a conversion format designated at the discretion of the user is also stored in the conversion information storage unit 54 as the format conversion adapted information in the same manner as described above.

A command to create the format conversion adapted information is issued when the unsupported format information is updated, i.e., when the unsupported format information is stored in the unusable information storage unit 53 by the data processing unit 61.

Alternatively, the command to create the format conversion adapted information may be issued at the time of data transfer by the metabolic function.

The format conversion unit 63, upon reception of a request from the user terminal such as the first user terminal 20a or the second user terminal 20b to read the data corresponding to the data ID stored in the format conversion adapted information in the conversion information storage unit 54, reads the requested data from the electronic data storage unit 51 and copies the data. Specifically, the format conversion unit 63 reads out the original data 80 as the requested data from the electronic data storage unit 51 and creates the copied data 81 from the original data 80 (FIG. 2D). For example, the format conversion unit 63, upon reception of a request to read the data corresponding to “data ID: 1”, reads the data of “data ID:1” made up of the original data from the storage D1 and copies the data

Then, the format conversion unit 63 converts the type and/or the version of the copied data based on the format conversion adapted information stored in the conversion information storage unit 54, and transfers the converted data to the user terminal which issued the read request. Specifically, in the format conversion unit 63, the converted data 82 with the data format of the copied data 81 converted to the supported format based on the format conversion adapted information is transferred to the user terminal which issued the read request (FIG. 2D). For example, the format conversion unit 63, by accessing the format conversion adapted information illustrated in FIG. 2C, converts the copied data 81 of “data ID: 1” to the format of “type: OASYS for personal computer, version: V10”, and then transfers the conversion result to the user terminal which issued the read request.

Furthermore, the format conversion unit 63 checks the presence or absence of a computer virus in the data when transferring the data to the user terminal, and when the data is infected by the computer virus, exterminates the computer virus. Specifically, the format conversion unit 63, after exterminating the computer virus from the original data 80 infected by the computer virus, copies the original data 80 and transfers the converted data 82 of the copied data 81 to the user terminal (FIG. 2D). The computer virus may alternatively be exterminated after copying the original data 80.

The format conversion unit 63 confirms the consistency of the data using the hash value at the time of transferring the data to the user terminal. For example, the data processing unit 61 calculates the hash value of each block of data at the time of storing the data received from the user terminal, and stores the metadata with the calculated hash value in the data format storage unit 52. Then, the format conversion unit 63 compares the hash value when transferring the data in response to the read request from the user terminal, and thus may confirm the consistency of the data.

The examples described above are only illustrative, and the archive apparatus 10 according to the first embodiment may execute the process of converting various data formats including music and image data as well as text data.

[Steps of Processing by Archive Apparatus According to First Embodiment]

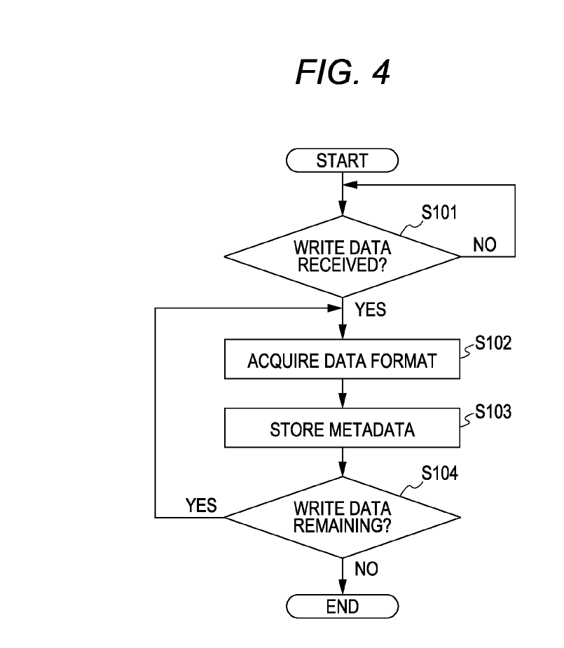

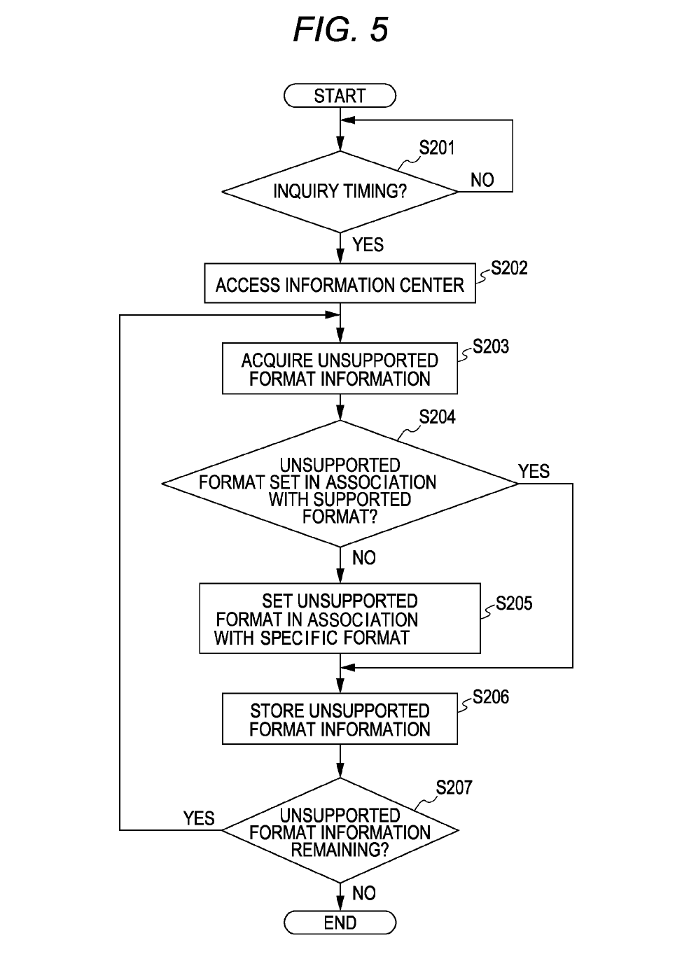

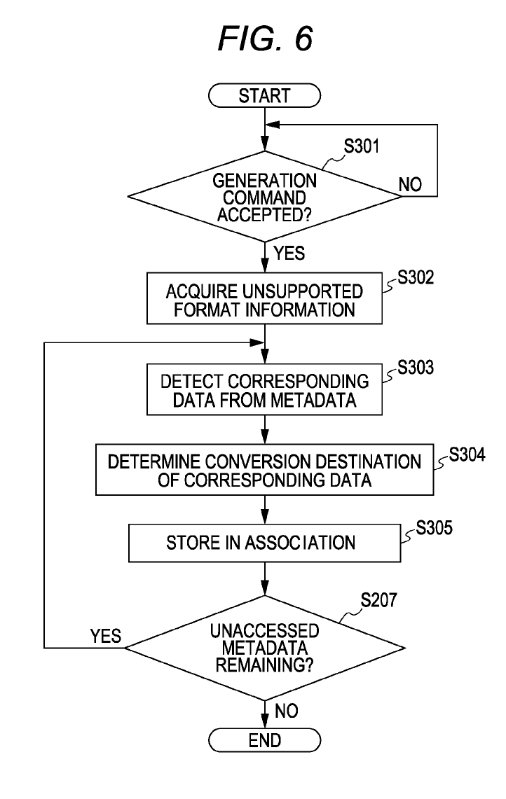

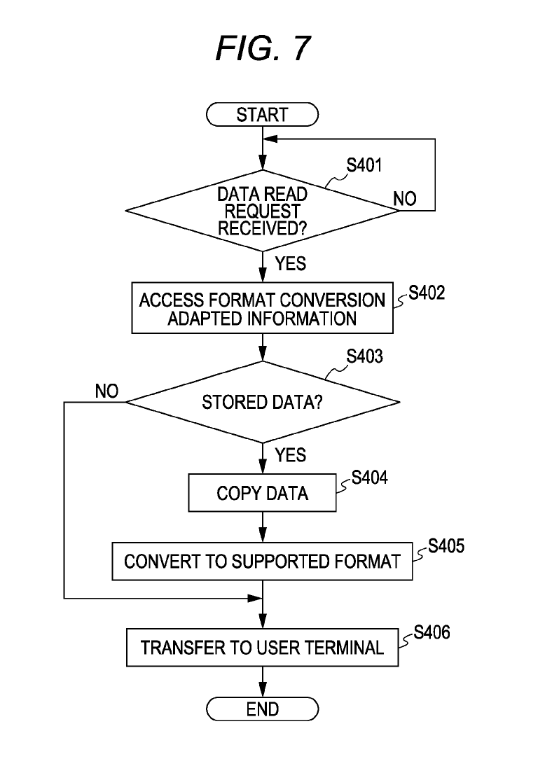

Next, the processing executed in the archive apparatus according to the first embodiment is described with reference to FIGS. 4, 5, 6, and 7. FIG. 4 is a diagram for describing the steps of the metadata storage processing according to the first embodiment. FIG. 5 is a diagram for describing the steps of the processing for creating the unsupported format information according to the first embodiment. FIG. 6 is a diagram for describing the steps of the processing for creating the format conversion adapted information according to the first embodiment. FIG. 7 is a diagram for describing the steps of the format conversion processing according to the first embodiment.

[Steps of Metadata Storage Processing According to First Embodiment]

As illustrated in FIG. 4, the archive apparatus 10 according to the first embodiment, upon reception of write data from a user terminal such as the first user terminal 20a or the second user terminal 20b (YES in operation S101), causes the data processing unit 61 to acquire the data format of the electronic data (hereinafter, referred to as “data”) that has been received (operation S102). Specifically, the data processing unit 61 acquires the type and the version of the application of the received data.

The data processing unit 61 stores the metadata with the acquired data format in the data format storage unit 52 (operation S103). For example, the data processing unit 61 generates metadata “data ID: 1, reception date: 19911011, storage ID: D1, transmitter: A, attribute information: I1, type: OASYS (registered trademark) for word processor only, version: 100GX-CD” and stores the metadata in the data format storage unit 52 (FIG. 2A). The data processing unit 61 stores the metadata with the data format in the data format storage unit 52 while storing the received data in the electronic data storage unit 51.

The data processing unit 61 judges whether any unprocessed write data remains or not (operation S104). If any unprocessed write data remains (YES in operation S104), the data processing unit 61 returns to operation S102 and acquires the data format of the write data.

If no unprocessed write data remains (NO in operation S104), on the other hand, the data processing unit 16 ends the process.

[Steps of Unsupported Format Information Storage Processing According to First Embodiment]

As illustrated in FIG. 5, with the arrival of the time to make an inquiry to the information center (YES in operation S201), the data processing unit 61 of the archive apparatus 10 according to the first embodiment, through the communication unit 30, accesses the information center connected to the network (operation S202). The information center manages the update history information of the type and the version of the applications installed in all if not most of the user terminals connected with the archive apparatus 10, and stores the unsupported formats and the supported formats at the user terminals as of the present time point.

The data processing unit 61 acquires, from the information center, the unsupported format information containing the presently unusable data format in association with the presently usable data format at a plurality of user terminals connected to the archive apparatus 10 (operation S203). Specifically, the data processing unit 61 acquires the unsupported format information containing, in association with each other, the presently unusable type and/or version of applications (unsupported formats) and the presently usable type and/or version of applications (supported formats).

For example, the data processing unit 61 acquires the unsupported format information “‘unsupported format, type: OASYS for word processor only, version: 100GX-CD’, ‘supported format, type: OASYS for personal computer, version: V10’”.

When the archive apparatus 10 is not connected to the information center through the network, on the other hand, the unsupported format information may be acquired by the manager of the archive apparatus 10 inputting the unsupported formats and the supported formats acquired from the information center to the archive apparatus 10. The manager acquires the unsupported formats and the supported formats from the information center, for example, at the time when the archive apparatus 10 is updated.

If it is desired to designate the unsupported format rapidly, the manager may input both the unsupported format of which designation is desired and the corresponding supported format to the archive apparatus 10.

The data processing unit 61, upon acquisition of the unsupported format information with the unsupported format and the supported format set in association with each other (YES in operation 204), stores the acquired unsupported format information in the unusable information storage unit 53 (operation S206). If the unsupported format information “‘unsupported format, type: OASYS for word processor only, version: 100GX-CD’, ‘supported format, type: OASYS for personal computer, version: V10’” is acquired, for example, the data processing unit 61 stores the acquired unsupported format information in the unusable information storage unit 53 (FIG. 2B).

Furthermore, if the acquired unsupported format information has the same type of data format but a different version, the data processing unit 61 stores the acquired unsupported format information in the unusable information storage unit 53 as in the aforementioned case. If the unsupported format information “‘unsupported format, type: OASYS for personal computer, version: V5’, ‘supported format, type: OASYS for personal computer, version: V10’” is acquired, for example, the data processing unit 61 stores the acquired unsupported format information in the unusable information storage unit 53 (FIG. 2B)

If the supported format changes to the unsupported format in the already stored unsupported format information, the data processing unit 61 updates the type and/or the version stored as the supported format to the presently usable type and/or version.

If the supported format is not set in association with the unsupported format (NO in operation S204), on the other hand, the data processing unit 61 sets a specific data format as the supported format in association with the unsupported format (operation S205). If the supported format cannot be acquired, for example, the data processing unit 61 sets “type: PDF” or “type: image format” as the supported format in association with the unsupported format.

In operation S206, the data processing unit 61 stores, in the unusable information storage unit 53, the unsupported format information containing the unsupported format in association with “type: PDF” or “type: image format” as the supported format.

If the supported format information with the unsupported format set in association with “type: PDF” or “type: image format” as the supported format is acquired, the data processing unit 61 updates “type: PDF” or “type: image format” in the unsupported format information to the acquired supported format information.

Now, the data processing unit 61 judges whether any unsupported format information remains or not (operation S207). Upon judgment that unsupported format information remains (YES in operation S207), the data processing unit 61 returns to operation S203 and acquires the remaining unsupported format information.

Upon judgment that no unsupported format information remains (NO in operation S207), on the other hand, the data processing unit 61 ends the process.

[Steps of Processing for Creating Format Conversion Adapted Information According to First Embodiment]

As illustrated in FIG. 6, the archive apparatus 10 according to the first embodiment, upon acceptance of a command to generate the format conversion adapted information (YES in operation S301), causes the conversion destination determining unit 62 to acquire the unsupported format information stored in the unusable information storage unit 53 (operation S302). For example, the conversion destination determining unit 62 acquires the unsupported format information “‘unsupported format, type: OASYS for word processor only, version: 100GX-CD’, ‘supported format, type: OASYS for personal computer, version: V10’” illustrated in FIG. 2B.

The timing at which a command is given to generate the format conversion adapted information may be, for example, when the data processing unit 61 stores the unsupported format information in the unusable information storage unit 53 or when the data is transferred by the metabolic function.

The conversion destination determining unit 62, using the acquired unsupported format information, detects the corresponding data from the metadata stored in the data format storage unit 52 (operation S303). Specifically, the conversion destination determining unit 62 detects, from the metadata stored in the data format storage unit 52, the data of the unsupported format in the unsupported format information stored in the unusable information storage unit 53. For example, the conversion destination determining unit 62 acquires the unsupported format “type: OASYS for word processor only, version: 100GX-CD” from the unsupported format information illustrated in FIG. 2B, and detects the corresponding data “data ID: 1” from the metadata illustrated in FIG. 2A.

After the detection, the conversion destination determining unit 62 determines the conversion destination of the unsupported format of the detected electronic data as the supported format set in association with the unsupported format in the unsupported format information (operation S304). For example, the conversion destination determining unit 62 determines the conversion destination of “data ID: 1” as the supported format, “type: OASYS for personal computer, version: V10” corresponding to the unsupported format “type: OASYS for word processor only, version: 100GX-CD” in the unsupported format information illustrated in FIG. 2B.

Then, the conversion destination determining unit 62, stores, in the conversion information storage unit 54, the format conversion adapted information set in association with the conversion destination determined for each block of data of the unsupported format in the unsupported format information (operation S305). For example, the conversion destination determining unit 62 stores the format conversion adapted information “‘data ID: 1’, ‘before conversion, type: OASYS for word processor only, version: 100GX-CD’, ‘after conversion, type: OASYS for personal computer, version: V10’” in the conversion information storage unit 54 (FIG. 2C).

Similarly, the conversion destination determining unit 62, using the unsupported format information stored in the unusable information storage unit 53, detects, from the metadata, data with the same type of data format OPP and an unsupported format version, and after determining the version of the conversion destination of the unsupported format, stores the format conversion adapted information in the conversion information storage unit 54. For example, the conversion destination determining unit 62 stores the format conversion adapted information “‘data ID: 2’, ‘before conversion, type: OASYS for personal computer, version: V5’, ‘after conversion, type: OASYS for personal computer, version: V10’” in the conversion information storage unit 54 (FIG. 2C).

The conversion destination determining unit 62 judges whether any unaccessed metadata remains or not (operation S306). Upon judgment that unaccessed metadata remains (YES in operation S306), the conversion destination determining unit 62 returns to operation S303, and detects the remaining data in the metadata.

Upon judgment that no unaccessed metadata remains (NO in operation 306), on the other hand, the conversion destination determining unit 62 ends the processing.

[Steps of Format Conversion Processing According to First Embodiment]

As illustrated in FIG. 7, the archive apparatus 10 according to the first embodiment, upon reception of a data read request from a user terminal such as the first user terminal 20a or the second user terminal 20b (YES in operation S401), causes the format conversion unit 63 to access the format conversion adapted information stored in the conversion information storage unit 54 (operation S402).

Then, the format conversion unit 63 judges whether the data corresponding to the received read request is stored in the format conversion adapted information or not (operation S403). If the data corresponding to the received read request is not stored in the format conversion adapted information (NO in operation S403), the format conversion unit 63 reads the corresponding data from the electronic data storage unit 51 and transfers the data thus read to the user terminal that executed the read request (operation S406).

If the data corresponding to the received read request is stored in the format conversion adapted information (YES in operation S403), on the other hand, the format conversion unit 63 reads the corresponding data from the electronic data storage unit 51 and copies the data (operation S404). Specifically, the format conversion unit 63 reads the original data 80 made up of the requested data from the electronic data storage unit 51, and creates the copied data 81 of the original data 80 (FIG. 2D). For example, the format conversion unit 63, upon reception of a request to read the data corresponding to “data ID: 1”, reads the data of “data ID: 1” made up of the original data 80 from the storage D1 and copies the data.

Then, the format conversion unit 63 converts the format or the version of the copied data based on the format conversion adapted information stored in the conversion information storage unit 54 (operation S405). Specifically, the format conversion unit 63 converts the data format of the copied data 81 to the supported format based on the format conversion adapted information. For example, the format conversion unit 63, by accessing the format conversion adapted information illustrated in FIG. 2C, converts the format of the copied data 81 of “data ID: 1” to “type: OASYS for personal computer, version: 10”.

After that, the format conversion unit 63 transfers the data converted to the supported format to the user terminal that issued the read request (operation S406). For example, the format conversion unit 63 transfers the data of “data ID: 1” converted to “type: OASYS for personal computer, version: 10” to the user terminal that issued the read request.

The format conversion unit 63, upon transferring the data to the user terminal, checks for the presence or absence of a computer virus in the data, and if the data is infected by a computer virus, exterminates the computer virus. Specifically, the format conversion unit 63, after exterminating the computer virus in the original data 80 infected by the computer virus, copies the original data 80 and transfers the converted data 82 from the copied data 81 to the user terminal (FIG. 2D). The computer virus may be exterminated also after copying the original data 80.

[Effects of First Embodiment]

As described above, according to the first embodiment, the data received from the terminals is stored in the electronic data storage unit 51. The metadata including the data format (the type and version of the application) of the data stored in the electronic data storage unit 51, is stored the data format storage unit 52. The unsupported format information containing the unsupported format unusable at the terminals in association with the usable supported format in place of the unsupported format is stored in the unusable information storage unit 53. Then, the conversion destination determining unit 62 detects the data corresponding to the unsupported format from the data format stored in the data format storage unit 52, and determines the conversion destination of the unsupported format of the detected data as the supported format set in association with the unsupported format in the unsupported format information. As a result, the data format of the saved data may be determined as the data format usable at a user terminal, so that the data read may be reliably used by a user. Furthermore, the situation in which the version becomes unusable may also be met properly, thereby making it possible for the user to more reliably use the read data.

Furthermore, in the conversion information storage unit 54 according to the first embodiment, the supported format determined as a conversion destination is stored as the format conversion adapted information for each block of data corresponding to the unsupported format detected by the conversion destination determining unit 62. The format conversion unit 63, upon reception of the request to read the data corresponding to the format conversion adapted information, copies the data and, after converting the copied data to the supported format, transfers the data to the user terminal. As a result, the data may be converted quickly to the supported format and transferred to the user terminal while saving the original data. Thus, the data format usable at the terminal may be determined, and the user may reliably use the read data.

### Second Embodiment

According to the first embodiment described above, the unsupported format information is created based on the information acquired from the information center or the information input by the manager of the archive apparatus 10. The second embodiment described below, on the other hand, represents a case in which the unsupported format information is automatically created by the archive apparatus 10.

[Outline and Features of Archive Apparatus 10 According to Second Embodiment]

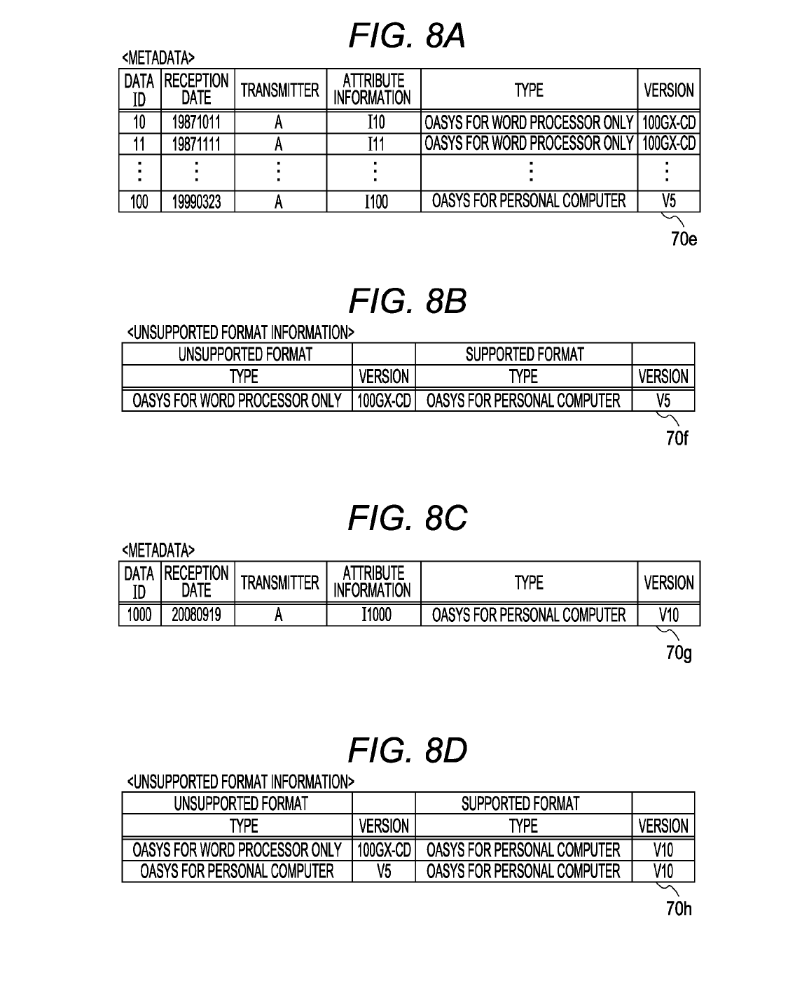

First, aspects of the archive apparatus according to the second embodiment are described with reference to FIG. 8. FIGS. 8A, 8B, 8C and 8D are diagrams for describing the outline and the features of the archive apparatus according to the second embodiment.

The archive apparatus 10 according to the second embodiment creates the unsupported format information using metadata. Specifically, the archive apparatus 10 according to the second embodiment creates the unsupported format information by accessing “the user terminal that has transmitted the data” and “the date at which the data is received” in the metadata. Specifically, when the format of the data received thus far continuously from the same transmitter is changed at a certain time point, the archive apparatus 10 according to the second embodiment determines the data format before the change as the unsupported format, and the data format after the change as the supported format corresponding to the unsupported format.

For example, the archive apparatus 10 according to the second embodiment, by accessing the metadata 70e illustrated in FIG. 8A, detects that the data format of the text data received from “transmitter: A (user terminal A)” is changed at the time point “reception date: 19990323 (Mar. 23, 1999)”. Specifically, the archive apparatus 10 detects that the data format of the text data is changed from “type: OASYS for word processor only, version: 100GX-CD” to “type: OASYS for personal computer, version: V5” at the time point of Mar. 23, 1999.

The archive apparatus 10 according to the second embodiment determines “type: OASYS for word processor only, version: 100GX-CD” as the unsupported format, and “type: OASYS for personal computer, version: V5” as the supported format.

The archive apparatus 10 according to the second embodiment, as illustrated in (B) of FIG. 8, stores “‘unsupported format, type: OASYS for word processor only, version: 100GX-CD’, ‘supported format, type: OASYS for personal computer, version: V5’” as the unsupported format information 70f.

Furthermore, when the metadata 70g illustrated in FIG. 8C is newly stored, the archive apparatus 10 according to the second embodiment detects that the data format of the text data received from “transmitter: A (user terminal A)” is changed again at the time point of “reception date: 20080919 (Sep. 19, 2008)”. Specifically, the archive apparatus 10 detects that the data format of the text data is changed from “type: OASYS for personal computer, version: V5” to “type: OASYS for personal computer, version: V10” at the time point of Sep. 19, 2008.

Then, the archive apparatus 10 according to the second embodiment determines “type: OASYS for personal computer, version: V5” as the unsupported format, and “type: OASYS for personal computer, version: V10” as the supported format.

The archive apparatus 10 according to the second embodiment, as illustrated in FIG. 8D, stores “‘unsupported format, type: OASYS for personal computer, version: V5’, ‘supported format, type: OASYS for personal computer, version: V10’” as the unsupported format information 70h. Furthermore, the archive apparatus 10 according to the second embodiment, as illustrated in FIG. 8D, updates the supported format corresponding to “unsupported format, type: OASYS for word processor only, version: 100GX-CD” to “supported format, type: OASYS for personal computer, version: V10”.

As described above, the archive apparatus 10 according to the second embodiment may create the unsupported format information in association with the operating situation of the user of the user terminal, so that the user may reliably utilize the data that has been read.

The examples described above are only illustrative. For example, the archive apparatus 10 according to the second embodiment may automatically create the unsupported format information of various data formats including music and image data as well as text data.

[Configuration of Archive Apparatus 10 According to Second Embodiment]

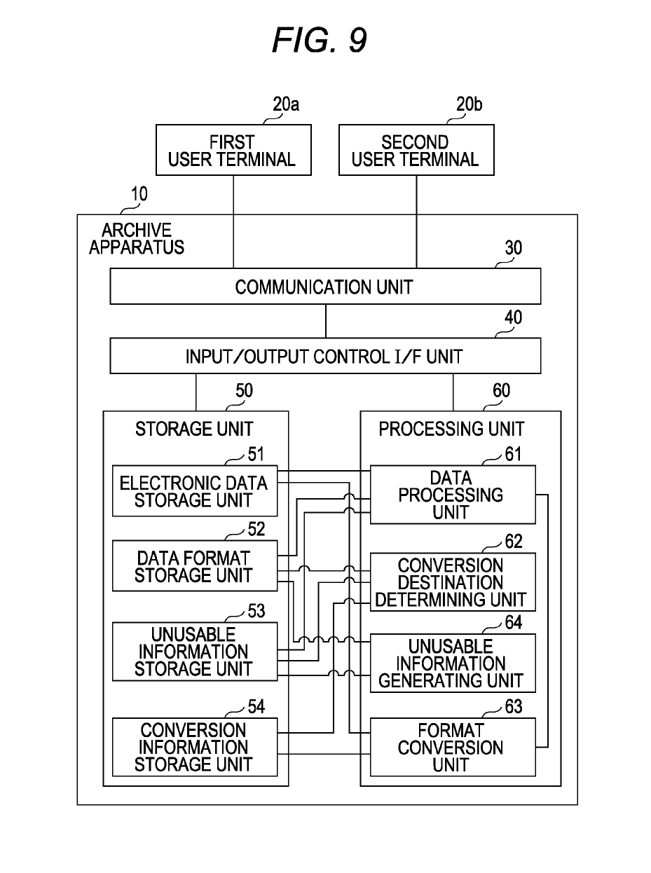

Next, the configuration of the archive apparatus 10 according to the second embodiment is described with reference to FIG. 9. FIG. 9 is a diagram for describing the configuration of the archive apparatus 10 according to the second embodiment.

The archive apparatus 10 according to the second embodiment, as illustrated in FIG. 9, is different from the archive apparatus 10 according to the first embodiment in that the former includes an unusable information generating unit 64. An explanation is given below with emphasis placed mainly on this point.

The unusable information generating unit 64 creates the unsupported format information using the metadata. Specifically, the unusable information generating unit 64 creates the unsupported format information by accessing “the transmitter for uniquely specifying the user terminal that has transmitted the data” and “the date at which the data is received” in the metadata. Specifically, when the data format of the data thus far received continuously from the same transmitter is changed at a certain time point, the unusable information generating unit 64 determines the data format before the change as the unsupported format, and the data format after the change as the supported format corresponding to the unsupported format.

For example, the unusable information generating unit 64, by accessing the metadata illustrated in FIG. 8A, detects that the data format of the text data received from “transmitter: A (user terminal A)” is changed at the time point of “reception date: 19990323 (Mar. 23, 1999)”. Specifically, the archive apparatus 10 detects that the data format of the text data is changed from “type: OASYS for word processor only, version: 100GX-CD” to “type: OASYS for personal computer, version: V5” at the time point of Mar. 23, 1999.

The unusable information generating unit 64 determines “type: OASYS for word processor only, version: 100GX-CD” as the unsupported format and “type: OASYS for personal computer, version: V5” as the supported format.

The unusable information generating unit 64 stores the unsupported format information containing, in association with each other, the unsupported format and the supported format thus determined, in the unusable information storage unit 53. For example, the unusable information generating unit 64, as illustrated in FIG. 8B, stores “‘unsupported format, type: OASYS for word processor only, version: 100GX-CD’, ‘supported format, type: OASYS for personal computer, version: V5’” as the unsupported format information in the unusable information storage unit 53.

The unusable information generating unit 64 creates the unsupported format information also for the data with the same data format type and a changed version. When the metadata illustrated in FIG. 8C is newly stored, for example, the unusable information generating unit 64 detects that the data format of the text data received from “transmitter: A (user terminal A)” is changed again at the time point of “reception date: 20080919 (Sep. 19, 2008)”. Specifically, the archive apparatus 10 detects that the data format of the text data is changed from “type: OASYS for personal computer, version: V5” to “type: OASYS for personal computer, version: V10” at the time point of Sep. 19, 2008.

Then, the unusable information generating unit 64 determines “type: OASYS for personal computer, version: V5” as the unsupported format, and “type: OASYS for personal computer, version: V10” as the supported format.

The unusable information generating unit 64, as illustrated in FIG. 8D, stores “‘unsupported format, type: OASYS for personal computer, version: V5’, ‘supported format, type: OASYS for personal computer, version: V10’” as the unsupported format information in the unusable information storage unit 53.

In the process, the unusable information generating unit 64 also updates the unsupported format information already stored in the unusable information storage unit 53. Specifically, the unusable information generating unit 64 updates the supported format of the already stored unsupported format information. For example, the unusable information generating unit 64, as illustrated in FIG. 8D, updates the supported format corresponding to “unsupported format, type: OASYS for word processor only, version: 100GX-CD” to “supported format, type: OASYS for personal computer, version: V10”.

[Steps of Processing for Automatically Creating Unsupported Format Information According to Second Embodiment]

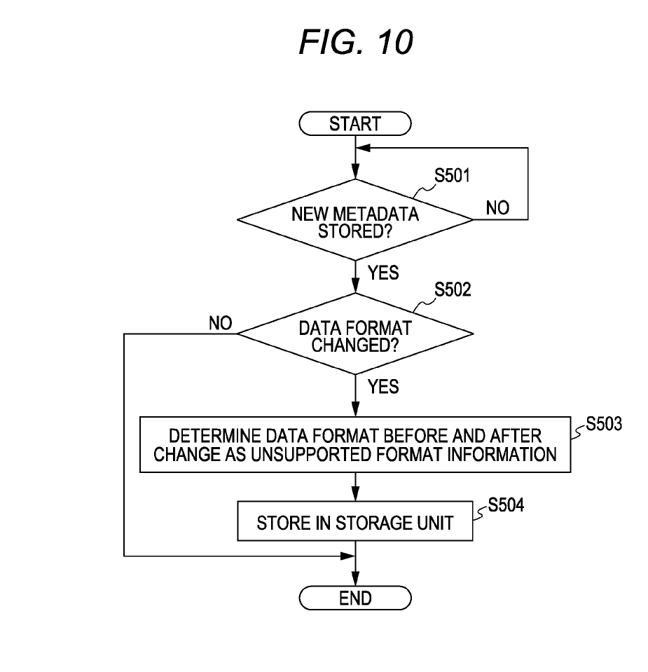

Next, with reference to FIG. 10, the steps of the processing for automatically creating the unsupported format information according to the second embodiment are described. FIG. 10 is a diagram for describing the steps of the processing for automatically creating the unsupported format information according to the second embodiment.

As illustrated in FIG. 10, when new metadata is stored in the data format storage unit 52 by the process of the data processing unit 61 (YES in operation S501), the unusable information generating unit 64 of the archive apparatus 10 according to the second embodiment accesses the metadata newly stored, and judges whether the data format of the data thus far received from the same transmitter is changed or not (operation S502). Specifically, the unusable information generating unit 64 judges whether the data format of the same type of data received from the same transmitter is changed or not by referencing “the user terminal that has transmitted the data” and “the reception date at which the data is received” of the metadata newly stored.

If the format of this data is not changed (NO in operation S502), the archive apparatus 10 according to the second embodiment ends the process.

If the format of the data is changed (YES in operation S502), on the other hand, the unusable information generating unit 64 determines the data format before and after the change as the unsupported format information (operation S503). Specifically, the unusable information generating unit 64 determines the data format before change as the unsupported format, and the data format after change as the supported format corresponding to the unsupported format.

If the metadata of “data ID: 100” illustrated in FIG. 8A is newly stored, for example, the unusable information generating unit 64 detects that the data format of the text data is changed. The unusable information generating unit 64 determines “type: OASYS for word processor only, version: 100GX-CD” as the unsupported format, and “type: OASYS for personal computer, version: V5” as the supported format.

Furthermore, when the metadata of “data ID: 1000” illustrated in FIG. 8C is newly stored, the unusable information generating unit 64 detects that the data format of the text data is changed again. The unusable information generating unit 64 determines “type: OASYS for personal computer, version: V5” as the unsupported format and “type: OASYS for personal computer, version: V10” as the supported format. Further, the unusable information generating unit 64 decides to update the supported format corresponding to the unsupported format “type: OASYS for word processor only, version: 100GX-CD” to “type: OASYS for personal computer, version: V10”.

Then, the unusable information generating unit 64 stores the unsupported format information thus determined in the unusable information storage unit 53 (operation S504), and ends the process.

The unusable information generating unit 64 may generate the unsupported format information either each time new metadata is stored or collectively at a regular time interval preset by the manager.

[Effects of Second Embodiment]

According to the second embodiment, as described above, the unusable information generating unit 64 creates the unsupported format information using the metadata of the saved data by the user. The unsupported format information created by the unusable information generating unit 64 is stored in the unusable information storage unit 53. As a result, the unsupported format information corresponding to the data format used by the user may be automatically created by the archive apparatus 10, thereby making it possible for the user to use the read data more reliably.

According to the second embodiment, the data format storage unit 52 stores “data transmitter” and “data reception date”. When the data format of the data thus far received continuously from the same transmitter is changed at a certain time point, the unusable information generating unit 64 determines the data format before being changed as the unsupported format, and the data format after being changed as the supported format corresponding to the unsupported format thereby to generate the unusable information. As a result, the unsupported format information may be created based on the result of detailed analysis of the data format used by the user.

Furthermore, according to the second embodiment, the type and version of the application used at the time of data creation are stored in the data format storage unit 52 as the data format. When the version of the data containing the same type of application thus far continuously received from a user terminal is changed at a certain time point, the unusable information generating unit 64 determines the version before being changed as the unsupported format and the version after being changed as the supported format corresponding to the unsupported format so as to generate the unusable information. In this way, the situation in which the version becomes unusable may be met, and the read data may be more reliably utilized by the user.

### Third Embodiment

Apart from the first and second embodiments described above, the present invention may be embodied in various forms other than the first and second embodiments. Now, various different embodiments are described by classifying the examples as (1) to (4) as described below.

(1) Creation of Unsupported Format Information

In the first and second embodiments, the archive apparatus 10 acquires the unsupported format information from the information center or from the manager of the archive apparatus 10, and the archive apparatus 10 creates the unsupported format information. The invention, however, is not limited to these cases, and the archive 10 may employ both of the above two methods at the same time.

(2) Conversion of Data Format

Furthermore, the first and second embodiments described above represent a case in which the data of the unsupported format is copied and converted to the supported format at the time of issuing a read request from the user terminal. The invention, however, is not limited to these embodiments, and for example, upon detection of the data in the unsupported format, the detected data may be copied and converted to the supported format.

Furthermore, the first and second embodiments are described above with reference to a case in which the data format is converted by the archive apparatus 10 having stored therein the unsupported format information and the conversion information. This invention, however, is not limited to such a case, and the unsupported format information and the conversion information to convert the data format may be stored in a conversion apparatus connected to the archive apparatus 10.

(3) System Configuration, etc.

Furthermore, the processing steps, the specific names and the information including the various data and parameters described in the embodiments above may be arbitrarily updated unless otherwise specified. For example, the date and time at which the data is accessed may be added to the metadata stored in the data format storage unit 52 according to the first and second embodiments.

Further, each component element of the devices illustrated in the drawings is a conceptual function and not necessarily coincident with the component element physically illustrated. Specifically, the specific forms (the form illustrated in FIG. 3, for example) of distribution and integration of each processing unit and each storage unit are not limited to the illustrated forms. For example, the conversion destination determining unit 62 and the format conversion unit 63 may be integrated with each other. Further, the whole or an arbitrary part of the processing function to be performed by each device may be implemented by a CPU or a program analyzed and executed by the CPU, or by wired logic or hardware.

(4) Conversion Program

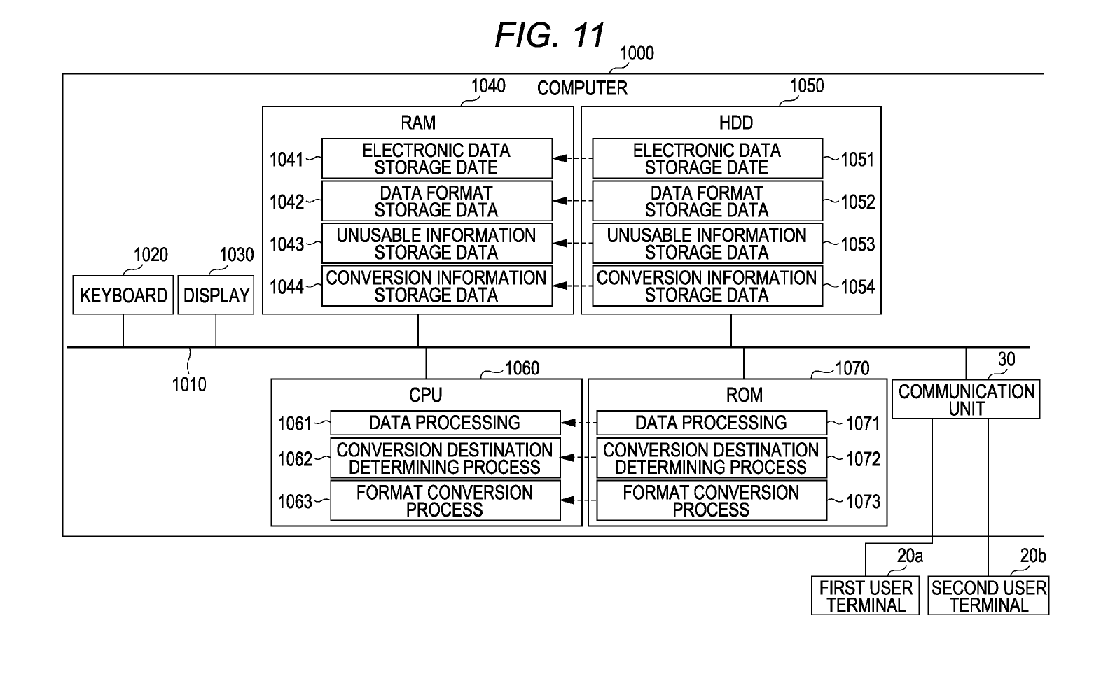

Although the first and second embodiments are described above with reference to a case in which the various processes are realized by hardware logic, the invention is not limited to such a case, and a program prepared in advance may be executed by the computer. An example of the computer for executing a conversion program having a similar function to the archive apparatus 10 according to the first embodiment is described with reference to FIG. 11. FIG. 11 is a diagram for describing the computer which executes the conversion program according to the first embodiment.

As illustrated in FIG. 11, a computer 1000 as an information processing system includes a keyboard 1020, a display 1030, a RAM 1040, a HDD 1050, a CPU 1060, a ROM 1070, and a communication unit 30. The keyboard 1020, the display 1030, the RAM 1040, the HDD 1050, the CPU 1060, the ROM 1070, and the communication unit 30 are interconnected by a bus 1010, etc. Further, the computer 1000, as illustrated in FIG. 11, is connected to the first user terminal 20a and the second user terminal 20b through the communication unit 30.

The ROM 1070 has stored therein a conversion program adapted to exhibit the same function as the archive apparatus 10 according to the first embodiment. That is to say, a data processing program 1071, a conversion destination determining program 1072, and a format conversion program 1072 are stored in advance as illustrated in FIG. 11. The programs 1071 to 1073 may be appropriately integrated or distributed like the respective component elements of the archive apparatus 10 illustrated in FIG. 3.

The CPU 1060 reads and executes the programs 1071 to 1073 from the ROM 1070, so that as illustrated in FIG. 11, the programs 1071 to 1073 may function as data processing 1061, a conversion destination determining process 1062, and a format conversion process 1063, respectively. The processes 1061 to 1063 correspond to the data processing unit 61, the conversion destination determining unit 62 and the format conversion unit 63, respectively, illustrated in FIG. 3.

As illustrated in FIG. 11, the HDD 1050 contains an electronic data storage data 1051, a data format storage data 1052, an unusable information storage data 1053, and a conversion information storage data 1054. The electronic data storage data 1051, the data format storage data 1052, the unusable information storage data 1053, and the conversion information storage data 1054 correspond to the electronic data storage unit 51, the data format storage unit 52, the unusable information storage unit 53 and the conversion information storage unit 54, respectively, illustrated in FIG. 3. The CPU 1060 registers the electronic data storage data 1041, the data format storage data 1042, the unusable information storage data 1043, and the conversion information storage data 1044 in the electronic data storage data 1051, the data format storage data 1052, the unusable information storage data 1053, and the conversion information storage data 1054, respectively, and by reading the electronic data storage data 1041, the data format storage data 1042, the unusable information storage data 1043, and the conversion information storage data 1044, stores the data in the RAM 1040. The CPU 1060 executes the conversion process based on the electronic data storage data 1041, the data format storage data 1042, the unusable information storage data 1043, and the conversion information storage data 1044 stored in the RAM 1040.

The programs 1071 to 1073 described above are not necessarily stored in the ROM 1070 from the beginning. Instead, each program may be stored in, for example, a portable physical medium such as a flexible disk (FD), a CD-ROM, a MO disk, a DVD disk, a magneto optic disk, or an IC card inserted in the computer 1000, a fixed physical medium such as a HDD arranged in or outside the computer 1000, or other computers (or servers) connected to the computer 1000 through the public telephone line, the internet, LAN or WAN, so that each program may be read and executed by the computer 1000.

With the apparatus disclosed herein, the read data may be reliably utilized by the user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An archive apparatus including a plurality of recording media and a processing unit that executes writing into the plurality of recording media and reading from the plurality of recording media, the apparatus further comprising:
an electronic data storage unit that stores electronic data received from a terminal;
a data format storage unit that stores a data format of the electronic data stored in the electronic data storage unit;
an unusable information storage unit that stores an unusable data format unusable at the terminal and a usable data format usable in place of the unusable format at the terminal in association with each other as unusable information; and
a conversion destination determining unit that detects, in the data format storage unit, the electronic data of the data format corresponding to the unusable data format of the unusable information stored in the unusable information storage unit, and determines a conversion destination of the unusable data format of the detected electronic data as a usable data format corresponding to the unusable data format of the unusable information.

2. The archive apparatus according to claim 1, further comprising an unusable information generating unit that generates the unusable information based on the data format stored in the data format storage unit,
wherein the unusable information storage unit stores the unusable information generated by the unusable information generating unit.

3. The archive apparatus according to claim 2,
wherein the data format storage unit stores the data format of the electronic data in association with a transmission terminal identifier for uniquely identifying the terminal having transmitted the electronic data, and with a time point when the electronic data is received, and
wherein when the format of the electronic data received continuously from the same terminal is changed to another data format at a certain time point, the unusable information generating unit determines that the data format before being changed is the unusable data format and that the data format after being changed is the usable data format corresponding to the unusable data format, so as to generate the unusable information.

4. The archive apparatus according to claim 2,
wherein the data format storage unit stores, as the data format of the electronic data, a type and a version of an application used when creating the electronic data stored in the electronic data storage unit, and
wherein when the version of the electronic data including the same type of the application received continuously from the same terminal is changed at a certain time point, the unusable information generating unit generates the unusable information by determining that the version before being changed is the unusable data format and that the version after being changed is the usable data format corresponding to the unusable data format.

5. The archive apparatus according to claim 1, further comprising:
a conversion information storage unit that stores, as conversion information, the usable data format determined to be the conversion destination of electronic data detected by the conversion destination determining unit, and
a format conversion unit which, upon reception of a request to read the electronic data corresponding to the conversion information stored in the conversion information storage unit, copies the electronic data and converts the copied electronic data to the usable data format of the conversion information.

6. A conversion apparatus included in an archive apparatus, the conversion apparatus comprising:
a data format storage unit that stores a data format of electronic data received from a terminal;
an unusable information storage unit that stores unusable information containing an unusable data format unusable at the terminal and a usable data format usable in place of the unusable data format at the terminal, in association with each other; and
a conversion destination determining unit that detects, in the data format storage unit, the electronic data of the data format corresponding to the unusable data format of the unusable information stored in the unusable information storage unit, and that determines that the conversion destination of the unusable data format of the detected electronic data is a usable data format corresponding to the unusable data format in the unusable information.

7. The conversion apparatus according to claim 6, further comprising an unusable information generating unit for generating the unusable information based on the data format stored in the data format storage unit,
wherein the unusable information storage unit stores the unusable information generated by the unusable information generating unit.

8. The conversion apparatus according to claim 7,
wherein the data format storage unit further stores the data format of the electronic data in association with a transmission terminal identifier for uniquely identifying the terminal having transmitted the electronic data, and with a time point when the electronic data is received, and
wherein when the format of the electronic data received continuously from the same terminal is changed to another data format at a certain time point, the unusable information generating unit generates the unusable information by determining that the data format before being changed is the unusable data format and that the data format after being changed is the usable data format corresponding to the unusable data format.

9. The conversion apparatus according to claim 7,
wherein the data format storage unit stores, as the data format of the electronic data, a type and a version of an application used when creating the electronic data, and
wherein when the version of the electronic data containing the same type of the application received continuously from the same terminal is changed at a certain time point, the unusable information generating unit determines that the version before being changed is the unusable data format and the version after being changed is the usable data format corresponding to the unusable data format, so as to generate the unusable information.

10. The conversion apparatus according to claim 6, further comprising:
a conversion information storage unit that stores, as conversion information, the usable data format determined to be the conversion destination of electronic data detected by the conversion destination determining unit, and
a format conversion unit which, upon reception of a request to read the electronic data corresponding to the conversion information stored in the conversion information storage unit, copies the electronic data and converts the copied electronic data to the usable data format of the conversion information.

11. A computer readable recording medium storing a conversion program to be executed by a computer, the conversion program causing a processor of the computer to execute:
storing a data format of electronic data received from a terminal, in a first storage unit;
storing an unusable data format unusable at the terminal and a usable data format usable in place of the unusable data format at the terminal, as usable information in association with each other; and
detecting, in the first storage unit, the electronic data of the data format corresponding to the unusable data format of the unusable information stored in a second storage unit, and determining that a conversion destination of the unusable data format of the detected electronic data is a usable data format corresponding to the unusable data format in the unusable information.

12. The conversion program according to claim 11 further causing the processor to execute:
generating the unusable information based on the data format stored in the first storage unit;
wherein the second storage unit stores the generated unusable information.

13. The conversion program according to claim 12,
wherein the first storage unit stores the data format of the electronic data in association with a transmission terminal identifier for uniquely identifying the terminal having transmitted the electronic data, and with a time point when the electronic data is received, and
wherein when the format of the electronic data received continuously from the same terminal is changed to another data format at a certain time point, the unusable information is generated by determining that the data format before being changed is the unusable data format, and that the data format after being changed is the usable data format corresponding to the unusable data format.

14. The conversion program according to claim 12,
wherein the first storage unit stores, as the data format of the electronic data, a type and a version of an application used when creating the electronic data, and
wherein when the version of the electronic data containing the same type of the application received continuously from the same terminal is changed at a certain time point, the unusable information is generated by determining that the version before being changed is the unusable data format and the version after being changed is the usable data format corresponding to the unusable data format.

15. The conversion program according to claim 11 causing the processor of the computer to execute:
causing a third storage unit to store, as the conversion information, the usable data format determined as the conversion destination of the detected electronic data, and
upon reception of a request to read the electronic data corresponding to the conversion information stored in the third storage unit, copying the electronic data and converting the copied electronic data to the usable data format of the conversion information.
